(19) United States
(12) Patent Application Publication
(10) Pub. No.: US 2006/0263474 A1
(43) Pub. Date: Nov. 23, 2006

(54) Enhanced flavor-release comestible compositions and methods for same

(75) Inventor: Shiuh Luo, Livingston, NJ (US)

Correspondence Address: HOFFMANN & BARON, LLP, 6900 JERICHO TURNPIKE, SYOSSET, NY, 11791, US

(73) Assignee: Cadbury Adams USA LLC.

(21) Appl. No.: 11/135,149

(22) Filed: May 23, 2005

(51) Int. Cl. A23G 4/00

(52) U.S. Cl. 426/3

(57) ABSTRACT

Included are compositions having at least one surfactant and at least one flavor. The surfactant may optionally be encapsulated and optionally have an HLB of seven or greater. The surfactant and flavor may be included in a comestible composition such as a gum composition.

### FIELD

Included are compositions having an encapsulated surfactant with HLB of about seven or greater. Also included are comestible compositions having a surfactant which may optionally be encapsulated.

### BACKGROUND

One factor that may influence a choice of a chewing gum is the ability of the chewing gum to deliver such organoleptic perceptions as flavor, sweetener, breath freshability and other sensory perceptions. However, as a piece of chewing gum is consumed, it is typical that a loss of flavor will be perceived. This perception results even though most of the flavor ingredients are still present in the chewing gum mass or bolus. During chewing, a large percentage of the flavor present in the gum composition, e.g., up to about 90% or more becomes trapped in the gum base and for purposes of the user, the gum has lost the perception of flavor. When the chewing gum loses its perceptible flavor it may become less desirable to the consumer, and is often discarded as being “flavorless”. Providing an increase in the time during which the flavor may be perceived, may increase the time during which the composition will be chewed, the goal being to provide the longest possible period of flavor perception.

One method of increasing flavor is to add additional gum pieces in the mouth. An example of a product that is marketed in this manner is Topps® Bazooka® Booster™ bubble gum and candy. When the consumer perceives a loss of flavor in the chewing gum composition, small bubble gum pieces in a pellet form may be added which provide additional flavor. While this approach provides a period of extended flavor, this is achieved by adding additional gum pieces rather than maximizing the release of flavor present in the chewing gum composition. The flavor trapped inside the originally chewed gum piece remains undetected by the consumer. The only enhancement of flavor is due to the addition of flavored gum.

A need exists for compositions which provide increased flavor release without the addition of more gum composition or other edible compositions during chewing. There is a need for a chewing gum composition which releases a greater amount of flavor which would otherwise be trapped in the gum base, thereby making it available to the consumer for enhanced flavor perception.

### SUMMARY

Provided herein are compositions and methods for controlling, extending and/or increasing the flavor release of gum compositions. In some embodiments, these compositions may include a surfactant having an HLB which is sufficient to produce an increased flavor perception attenuated over time. For example the flavor may be caused to have an initial high flavor impact, and a sustained flavor impact for combinations thereof over the chew. Different flavor release rates may be controlled and tailored through the incorporation of various surfactants in the free or unencapsulated state, or in the encapsulated state. In some embodiments, the surfactant may have an HLB of about seven or greater which further aids in releasing flavors from gum compositions which will otherwise be trapped within the gum compositions.

In some embodiments, there is an encapsulated composition including:
(a) a core material including at least one surfactant; and
(b) an exterior coating encapsulating the core including a material selected from cellulose, cellulose derivatives, starches, carbohydrates, gums, polyolefins, polyesters, waxes, vinyl polymers, gelatin, zein, and combinations thereof,
   optionally, the HLB of the encapsulated composition may be about seven or greater and may also optionally include free surfactant.

In some embodiments there is provided a delivery composition including this encapsulated compositions. In some embodiments, the delivery composition is a chewing um composition.

Some embodiments provide a comestible composition including a carrier matrix and a composition including (i) at least one flavor and (ii) at least one surfactant having an HLB of about seven or greater. In some embodiments, some or all of the surfactant is encapsulated.

In other embodiments there is provided a chewing gum composition comprising a gum base; at least one flavor; and at least one surfactant. The surfactant may optionally be encapsulated. In some embodiments the surfactant may have and HLB of seven or greater.

In some embodiments, there is a method of extending flavor which includes providing a chewing gum composition which includes a gum base, at least one flavor, and at least one encapsulated surfactant. The composition used in this method may optionally have some free surfactant present and optionally may have some or all of the surfactant having and HLB of seven or greater.

In other embodiments there is provided a method of extending release of flavor from a gum composition which includes providing a gum composition which includes a gum base, at least one flavor and at lease one surfactant having an HLB of about seven or greater. In some embodiments, some or all of the surfactant is encapsulated.

Some embodiments also provide a method of increasing flavor release from a gum composition which includes (a) providing a gum composition including a gum base and a flavor; (b) chewing said gum composition; and (c) adding a surfactant to said gum composition during chewing. In some embodiments, some or all of the surfactant is encapsulated. The surfactant optionally may have and HLB of seven or greater.

Also provided is a method of providing extended flavor release in a chewable composition including (a) providing a chewable matrix; and (b) combining said matrix with a flavor and encapsulated surfactant particles. In some embodiments, the chewable matrix is a gum base. The surfactant may be chosen from surfactants having an HLB of seven or greater, and encapsulated surfactant or a combination thereof.

### BRIEF DESCRIPTION OF THE DRAWINGS

The following drawings are illustrative of embodiments of the present inventions and are not intended to limit the invention as encompassed by the claims forming part of the application.

FIG. 1 is a graph showing the flavor release per minute per chew time of a control composition compared to two inventive gum compositions including a surfactant, polysorbate 65, having an HLB of 10.5.

FIG. 2 is a graph showing the effect of surfactant addition on the perceived intensity of flavor.

### DETAILED DESCRIPTION

The compositions herein include a flavor in combination with a surfactant. This composition may be included in a gum base as part of a chewing gum composition. In the compositions having free or unencapsulated surfactant, an increase in flavor release from the gum may result. In the compositions including an encapsulated surfactant, there are several benefits. One is an increase in the overall release of flavor from the gum. Another is an extended period of flavor release. In other words, where an encapsulated surfactant is present, the surfactant may be released gradually, which permits a gradual release of flavor from the gum composition.

In a gum composition there may be different surfactants and surfactants having different coatings. These combinations provide additional benefits. The coatings or encapsulating materials may themselves be different in composition and thickness. The effect of the surfactant combination and/or inclusion of differently coated surfactant particles effects the release rate of the surfactant into the gum composition. As surfactant is released into the gum composition, which may occur in distinct “spikes” as the surfactant in different particles is released, flavor which was been trapped into the gum base is released. Therefore, the consumer perceives the release of surfactant as sudden release of flavor, i.e., a flavor “spike” or a “hit” of flavor. Each flavor “spike” may result in renewed interest in the gum composition by the consumer. The combination of different surfactant particles may be tailored to provide one or more flavor “spikes” throughout the chewing of the gum composition.

As used herein the transitional term “comprising,” (also “comprises,” etc.) which is synonymous with “including,” “containing,” or “characterized by,” is inclusive or open-ended and does not exclude additional, unrecited elements or method steps, regardless of its use in the preamble or the body of a claim.

As used herein, the terms “bubble gum” and “chewing gum” are used interchangeably and are both meant to include any gum compositions.

As used herein, the term “active” refers to any composition which may be included in the encapsulated compositions of some embodiments, wherein the active provides some desirable property upon release from encapsulation. Examples of suitable actives include sweeteners, such as sucralose, flavors, medicaments, vitamins, and combinations thereof.

As used herein, the term “encapsulating material” includes any one or more water insoluble polymers, co-polymers, or other materials capable of forming a solid or strong coating or film as a protective barrier or layer around one or more ingredients and/or capable of forming a matrix with the one or more ingredients. In some embodiments, the encapsulating material may completely surround, cover, coat, or enclose an ingredient. In other embodiments, the encapsulating material may only partially surround, cover, coat, or enclose the ingredient. Different encapsulating materials may provide different release rates or release profiles for the encapsulated ingredient.

The term “sensate” is meant to include cooling, warming, tingling, or other agents which affect sensory perception. The agents may provide various perception attributes such as breath freshening and spiciness.

Included are compositions and methods for increasing and/or extending the release of flavors in chewing or bubble gum compositions. The compositions include at least one surfactant having an HLB capable of creating an oil in water dispersion when combined with a flavor oil and an aqueous medium. Specifically, the HLB may be greater than about seven. The surfactant may optionally be encapsulated depending on the desired effect. As described above, encapsulating includes partial encapsulation as well as the formation of a matrix or complex between the surfactant and the encapsulating material. In some embodiments there are also encapsulated surfactant particles. In some embodiments there are combinations of free and encapsulated surfactants.

The surfactant or encapsulated surfactant may be combined with a flavor in any suitable carrier matrix. The carrier matrix may be chewable or non-chewable, and water soluble or non-water soluble. The matrix may be chosen from a variety of comestible compositions which include, but are not limited to, gum compositions, hard candy compositions, soft candy compositions, such as those with a taffy consistency or combinations thereof.

The encapsulated compositions may include a core material including one or a combination of different surfactants wherein at least one surfactant has HLB of about seven or greater. Other actives may also be combined in the core material. The core material is surrounded by an exterior coating which encapsulates the core material.

Any of a variety of active ingredients may be included in the present embodiments. These include sweeteners, flavors, breath-freshening agents, medicaments or pharmaceutical actives, such as analgesics, anti-histamines, decongestants, and antacids, vitamins and other dietary supplements, breath freshening agents, caffeine, nicotine, and combinations thereof.

Suitable sweeteners may be selected from a wide range of materials including water-soluble sweeteners, water-soluble artificial sweeteners, water-soluble sweeteners derived from naturally occurring water-soluble sweeteners, dipeptide based sweeteners, and protein based sweeteners, including mixtures thereof. Without being limited to particular sweeteners, representative categories and examples include:

(a) water-soluble sweetening agents such as dihydrochalcones, monellin, steviosides, glycyrrhizin, dihydroflavenol, and sugar alcohols such as sorbitol, mannitol, maltitol, and L-aminodicarboxylic acid aminoalkenoic acid ester amides, such as those disclosed in U.S. Pat. No. 4,619,834, which disclosure is incorporated herein by reference, and mixtures thereof;

(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof;

(c) dipeptide based sweeteners, such as L-aspartic acid derived sweeteners, such as L-aspartyl-L-phenylalanine methyl ester (Aspartame) and materials described in U.S. Pat. No. 3,492,131, L-alphaaspartyl-N-(2,2,4,4-tetramethyl-3-thietanyl)-D-alaninamide hydrate (Alitame), N-[N-(3,3-dimethylbutyl)-L-aspartyl]-L-phenylalanine 1-methyl ester (Neotame); methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and mixtures thereof;

(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructofuranoside, or 4,1′-dichloro-4,1′-dideoxygalactosucrose; 1′,6′-dichloro 1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1 ′,6′-trichloro-6,1′,6′-trideoxysucrose; 4,6-dichloro-4,6-dideoxy-alpha-D-galacto-pyranosyl-1,6-dichloro-1,6-dideox y-beta-D-fructofuranoside, or 4,6,1′,6′-tetrachloro4,6,1′,6′-tetradeoxygalacto-sucrose; and 4,6,1′,6′-tetradeoxy-sucrose, and mixtures thereof; and

(e) protein based sweeteners such as thaumaoccous danielli (Thaumatin I and II).

The intense sweetening agents may be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and mixtures thereof.

In some embodiments wherein the active is a sweetener, it may be a high intensity sweetener such as sucralose, saccharin salts, acesulfame potassium, aspartame, thaumatin, neotame, alitame, and combinations thereof.

The flavoring agents which may be used include those flavors known to the skilled artisan, such as natural and artificial flavors. These flavorings may be chosen from synthetic flavor oils and flavoring aromatics and/or oils, oleoresins and extracts derived from plants, leaves, flowers, fruits, and so forth, and combinations thereof. Nonlimiting representative flavor oils include spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, and cassia oil. Also useful flavorings are artificial, natural and synthetic fruit flavors such as vanilla, and citrus oils including lemon, orange, lime, grapefruit, and fruit essences including apple, pear, peach, grape, strawberry, raspberry, cherry, plum, pineapple, apricot and so forth. These flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors.

Other useful flavorings include aldehydes and esters such as cinnamyl acetate, cinnamaldehyde, citral diethylacetal, dihydrocarvyl acetate, eugenyl formate, p-methylamisol, and so forth may be used. Generally any flavoring or food additive such as those described in Chemicals Used in Food Processing, publication 1274, pages 63-258, by the National Academy of Sciences, may be used. This publication is incorporated herein by reference. This may include natural as well as synthetic flavors.

Further examples of aldehyde flavorings include but are not limited to acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), cherry, grape, strawberry shortcake, and mixtures thereof.

In some embodiments, a flavoring agent may be employed in either liquid form and/or dried form. When employed in the latter form, suitable drying means such as spray drying the oil may be used. Alternatively, the flavoring agent may be absorbed onto water soluble materials, such as cellulose, starch, sugar, maltodextrin, gum arabic and so forth or may be encapsulated. The actual techniques for preparing such dried forms are well-known.

In some embodiments, the flavoring agents may be used in many distinct physical forms. Without being limited thereto, such physical forms include free forms, such as spray dried, powdered, beaded forms, encapsulated forms, and mixtures thereof.

The amount of flavoring agent employed herein may be a matter of preference subject to such factors as the type of final chewing gum composition, the individual flavor, the gum base employed, and the strength of flavor desired. Thus, the amount of flavoring may be varied in order to obtain the result desired in the final product and such variations are within the capabilities of those skilled in the art without the need for undue experimentation. In gum compositions, the flavoring agent is generally present in amounts from about 0.02% to about 5%, and more specifically from about 0.1% to about 2%, and even more specifically, from about 0.8% to about 1.8%, by weight of the chewing gum composition.

A variety of drugs, including medications, herbs, and nutritional supplements may also be included as the active to be encapsulated. Examples of useful drugs include ace-inhibitors, antianginal drugs, anti-arrhythmias, anti-asthmatics, anti-cholesterolemics, analgesics, anesthetics, anti-convulsants, anti-depressants, anti-diabetic agents, anti-diarrhea preparations, antidotes, anti-histamines, anti-hypertensive drugs, anti-inflammatory agents, anti-lipid agents, anti-manics, anti-nauseants, anti-stroke agents, anti-thyroid preparations, anti-tumor drugs, anti-viral agents, acne drugs, alkaloids, amino acid preparations, anti-tussives, anti-uricemic drugs, anti-viral drugs, anabolic preparations, systemic and non-systemic anti-infective agents, anti-neoplastics, anti-parkinsonian agents, anti-rheumatic agents, appetite stimulants, biological response modifiers, blood modifiers, bone metabolism regulators, cardiovascular agents, central nervous system stimulates, cholinesterase inhibitors, contraceptives, decongestants, dietary supplements, dopamine receptor agonists, endometriosis management agents, enzymes, erectile dysfunction therapies such as sildenafil citrate, which is currently marketed as Viagra®, fertility agents, gastrointestinal agents, homeopathic remedies, hormones, hypercalcemia and hypocalcemia management agents, immunomodulators, immunosuppressives, migraine preparations, motion sickness treatments, muscle relaxants, obesity management agents, osteoporosis preparations, oxytocics, parasympatholytics, parasympathomimetics, prostaglandins, psychotherapeutic agents, respiratory agents, sedatives, smoking cessation aids such as bromocryptine or nicotine, sympatholytics, tremor preparations, urinary tract agents, vasodilators, laxatives, antacids, ion exchange resins, anti-pyretics, appetite suppressants, expectorants, anti-anxiety agents, anti-ulcer agents, anti-inflammatory substances, coronary dilators, cerebral dilators, peripheral vasodilators, psycho-tropics, stimulants, anti-hypertensive drugs, vasoconstrictors, migraine treatments, antibiotics, tranquilizers, anti-psychotics, anti-tumor drugs, anti-coagulants, anti-thrombotic drugs, hypnotics, anti-emetics, anti-nauseants, anti-convulsants, neuromuscular drugs, hyper- and hypo-glycemic agents, thyroid and anti-thyroid preparations, diuretics, anti-spasmodics, terine relaxants, anti-obesity drugs, erythropoietic drugs, anti-asthmatics, cough suppressants, mucolytics, DNA and genetic modifying drugs, and combinations thereof.

Surfactants are characterized according to the “balance” between the hydrophilic (“water-loving”) and lipophilic (“oil-loving”) portions of their molecules. The hydrophilic-lipophilic balance (HLB) number indicates the polarity of the molecules in a range of 1-40, with the most commonly used emulsifiers having a value between 1 and 20. The HLB number increases with increasing hydrophilicity.

The surfactants may be selected from a wide range of surfactants, particularly food grade surfactants, which are known in the art. The surfactant may be capable of forming an oil and water emulsion with the flavor in the presence of water. The surfactant may have an HLB which is greater than about seven. Specifically, the surfactant may have an HLB of about twenty or less, more specifically from about fifteen or less, and even more specifically from about eleven to about fourteen.

Examples of useful surfactants include, but are not limited to, polyglycerol esters, ceteareth-20, sorbitan monostearate (Polysorbate 60), sorbitan monooleate (Polysorbate 80), sorbitan laurate (Polysorbate 20), sorbitan tristearate (Polysorbate 65), polyglyceryl laurate, glyceryl cocoate, acacia gum, acetylated monoglyceride, and combinations thereof. Polyglycerol esters include triglyceryl monostearate, hexaglyceryl distearate, decaglyceryl monostearate, decaglyceryl dipalmitate, decaglyceryl monooleate, and polyglyceryl 10 hexaoleate.

Where an encapsulated surfactant is desired, the encapsulation may be effected by any encapsulation or coating means known in the art. Among the suitable methods of encapsulation are extrusion and spray coating.

The surfactant and any other desired active may be combined with an encapsulating polymer by melt extrusion. This is conducted by melting a combination of one or more polymers in combination with the chosen surfactant(s) in the temperature range of about 65° C. to about 140° C. An active as described above may be added prior to melting the combination. The extrudate is then cooled and formed into particles of a desired size. This may be accomplished through cutting, grinding, pulverizing, milling or any other appropriate technique as know in the art. The extrudate particles may have an average particle size ranging from about 50 μm to about 800 μm.

The encapsulated surfactant particles of some embodiments may also be prepared by any suitable spray coating method as known in the art. One suitable process is the Wurster process. This process provides a method for encapsulating individual particulate materials. First the surfactant to be encapsulated (optionally in combination with an active) is suspended in a fluidizing air stream which provides a generally cyclic flow in front of a spray nozzle. The spray nozzle sprays an atomized flow of the coating solution which will include the encapsulating material in a suitable solvent. The atomized coating solution collides with the surfactant particles as they are carried away from the nozzle to provide a particle coating with the coating solution.

The temperature of the fluidizing air stream, which also serves to suspend the particles to be coated, may be adjusted to evaporate the solvent shortly after the coating solution contacts the particles. This serves to solidify the coating on the particles, resulting in the desired encapsulated particle. In some embodiments, the encapsulation material only partially encapsulate a surfactant particle.

This process may be repeated until the desired thickness of the coating is achieved. Alternatively, the process may be repeated with a different coating solution to provide different and distinct coating layers in the encapsulated particle composition.

Following the coating process, the particles may then be formed to an appropriate size as desired, generally from an average particle size range of about 50 μm to about 800 μm. This may be accomplished by any suitable means such as chopping, pulverizing, milling or grinding the particles. Within the encapsulated surfactant particles, the surfactant itself may be from about 0.01% to about 30%, by weight of said encapsulated particles, specifically from about 2% to about 30%, and more specifically from about 5% to about 20%.

The coating layer which surrounds the surfactant, may also include a solvent capable of dissolving the polymer. The solvent may be any solvent known for this purpose. For example, if the polymer is polyvinyl acetate, suitable solvents include of ethyl acetate, diethyl ether, acetone, benzene, ethylene dichloride, methanol, methyl ethyl ketone, ethanol, toluene, xylene, amyl acetate, and combinations thereof.

The extrusion and spray coating methods may be combined to provide a desired thickness of coating, and/or to provide a combination of different coating materials. For example, a surfactant may be encapsulated with one material such as polyvinyl acetate via the extrusion method and with a subsequent coating of another material, such as gum arabic via a spray coating method.

The coating or encapsulating material may be specifically prepared to have a desired tensile strength, especially where the encapsulated surfactant is included in a gum composition. The advantage of manipulating the tensile strength of the coating is to achieve the desired release rate of the core material, which will include the surfactant. This is desirable because as the surfactant is released into a gum composition from the encapsulating material, the surfactant enhances the release of flavor from the gum composition. By controlling or extending the release rate of the surfactant, the release rate and amount of the flavor from the gum is also affected and may be desirably extended or increased.

In some embodiments, the tensile strength of the encapsulation coating may be tailored by adding a tensile strength modifying agent to the coating. This is discussed in more detail in U.S. patent application Ser. No. 11/083,968 entitled “A Delivery System for Active Component as Part of an Edible Composition Having Preselected Tensile Strength” and filed on Mar. 21, 2005, which is a continuation-in-part application of, and claims priority to, U.S. patent application Ser. No. 10/719,298 entitled “A Delivery System for Active Components as Part of an Edible Composition” and filed Nov. 21, 2003, and claims priority to International Application No. PCT/US04/37185 filed Nov. 22, 2004, the contents of all of which are incorporated herein by reference for all purposes. The tensile strength modifying agent is selected from an encapsulating material to provide a coating with a combination of different encapsulating materials.

As used herein, the term “tensile strength” means the maximum stress a material subjected to a stretching load can withstand without tearing. A standard method for measuring tensile strength of a given substance is defined by the American Society of Testing Materials in method number ASTM-D638.

Examples of useful encapsulating materials include cellulose, cellulose derivatives, starches, carbohydrates, gums, polyolefms, proteins, polyesters, waxes, vinyl polymers, gelatin, zein and combinations thereof. Specific vinyl polymers include polyethylene, crosslinked polyvinyl pyrrolidone, polymethylmethacrylate, polylactic acid, polyhydroxyalkanoates, ethylcellulose, polyvinyl acetate phthalate, polyethyleneglycol esters, methacrylic acid-co-methylmethacrylate, acrylic polymers and copolymers, carboxyvinyl polymer, polyamides, polystyrene, polyvinyl acetate and combinations thereof. More specifically, the encapsulating material includes polyvinyl acetate, gum arabic, and combinations thereof.

In embodiments of wherein a tensile strength modifying agent is present, it is in an amount sufficient such that the tensile strength of the delivery system is at least about 6,500 psi, including 7500, 10,000, 20,000, 30,000, 40,000, 50,000, 60,000, 70,000, 80,000, 90,000, 100,000, 125,000, 135,000, 150,000, 165,000, 175,000, 180,000, 195,000, 200,000 and all ranges and subranges there between, for example a tensile strength range of 6,500 to 200,000 psi.

Examples of tensile strength modifiers or modifying agents include, but are not limited to, fats (e.g., hydrogenated or non-hydrogenated vegetable oils, animal fats), waxes (e.g., microcrystalline wax, bees wax), plasticizers/emulsifiers (e.g., mineral oil, fatty acids, mono- and diglycerides, triacetin, glycerin, acetylated monoglycerides, glycerol rosin monostearate esters), low and high molecular weight polymers (e.g., polypropylene glycol, polyethylene glycol, polyisobutylene, polyethylene, polyvinylacetate) and the like, and combinations thereof. Plasticizers may also be referred to as softeners.

By employing tensile strength modifiers, the overall tensile strength of the delivery system can be adjusted or altered in such a way that a preselected tensile strength is obtained for the corresponding desired release rate of the active component from an edible composition based on a comparison with a standard.

An ingredient in an edible composition will have a release profile when a consumer consumes the edible composition. In some embodiments, the ingredient may be released by mechanical action of the chewing, and/or by chemical action or reaction of the ingredient with another ingredient or saliva or other material in the consumer's mouth. The release profile for the ingredient is indicative of the availability of the ingredient in the consumer's mouth to interact with receptors (e.g., taste receptors), mucous membranes, teeth, etc. in the consumer's mouth. An edible composition may include the same or different release profiles for different ingredients. In some embodiments, the release profile for only a finite number (e.g., one or two) ingredients may be of primary importance.

The release profile of an ingredient in an edible composition can be influenced by many factors such as, for example, rate of chewing, intensity of chewing, the amount of the ingredient, how the form of the ingredient is added to the edible composition (e.g., encapsulated in a delivery system, unencapsulated, pretreated), how the edible composition is mixed or otherwise prepared, when or how the ingredient is added to other ingredients in the edible composition, the ratio of the amount of the ingredient to the amount of one or more other ingredients in the edible composition, the ratio of the amount of the ingredient to the amount of one or more other ingredients in a delivery system that is included in the edible composition, etc.

In some embodiments, a release profile for an ingredient may be related to a specific time period. For example, release of an ingredient from a delivery system may increase during a first time period, reach a peak, and then decrease during a second time period. Thus, in some embodiments, a release profile for an ingredient may include one or more time periods, each of which has an associated release rate (which may or may not be known or measurable). The time periods may be the same length of time or may be different lengths of time. A first time period may have a fixed or varied release rate for the ingredient during the first time period and an average release rate for the ingredient over the first time period. Similarly, a second time period may have a fixed or varied release rate for the ingredient during the second time period and an average release rate for the ingredient over the second time period. In some embodiments, a release profile for an ingredient in an edible composition may include only one time period or be related to only a single point in time, both of which typically relate or are relative to when consumption of the edible composition has started. In other embodiments, a release profile may relate to two or more time periods and/or two or more points in time, all of which typically relate or are relative to when consumption of the edible product has started.

In some embodiments, a release profile may be defined or characterized by one or more factors or characteristics, even if other or all aspects of the release profile are not determined, selected, or even known. Thus, in some embodiments, a release profile for an ingredient may include only one characteristic. For example, characteristics may include one or more of the following: release rate of an ingredient during a time period, a specific time period during which a minimum, average, or predominant amount of an ingredient is released during consumption of an edible composition that includes the ingredient (even if some of the ingredient is released before or after the specific time period and even if the release rate during the time period is not specified or varies), a specific time after which a minimum, average, or predominant amount if an ingredient is released during consumption of an edible composition that includes the ingredient (even if some of the ingredient is released before the specific time and even if the release rates are or are not specified), etc.

In some embodiments, managing a release profile for one or more ingredients may include changing or otherwise managing the starting and ending times for the time periods, changing or otherwise managing the lengths of the time periods, and/or changing or otherwise managing the release rates during the time periods. For example, managing a release profile may include changing or managing a release rate during a time period. An ingredient can be released more quickly or earlier during a first or second time period by increasing its release rate during these time periods. Likewise, the ingredient can be released more slowly or in a more delayed manner during the first or second time periods by decreasing its release rate during these time periods. As another example, managing a release profile may include shifting the start and end of the time periods in the release profile, but the length of the time periods may stay the same and the release rates of the ingredient(s) during the time periods may stay the same (e.g., the release of an ingredient may be managed to delay the release of the predominant amount of the ingredient by one minute, five minutes, ten minutes, thirty minutes, etc.). As a third example, managing a release profile may include shifting the start or end of one or more time periods and changing the release rate within the one or more time periods.

In some embodiments, causing a delay in a release of an ingredient in an edible composition includes causing a delay in the release or availability of the predominant amount of the ingredient after consumption of the edible product begins and/or causing release or availability of a desire, predominant, or minimum amount of the ingredient at a certain time, after a certain time, or during a desired time period after consumption of the edible composition begins. In some embodiments, none of the ingredient will be released or become available before the certain time or before or after the desired time period. In other embodiments, some of the ingredient may be released or become available before the certain time and/or before or after the desired time period.

In some embodiments, determining or selecting a desired release profile may include determining or selecting one or more factors or characteristics of the desired release profile, as previously described above. The factors or characteristics than serve to define or characterize the release profile, even if other or all aspects of the release profile are not determined or selected. Thus, determining or selecting a release profile for an ingredient can includes situations where only one characteristic for the release of the ingredient is determined or selected. In some embodiments, a characteristic may be determined or measured by one or more techniques or methods such as, for example, chemical and/or mechanical testing and analysis, consumer testing, descriptive or expert taste or chew panel, other in vivo or in vitro testing, etc.

The gum compositions may include one or more elastomers as a part of the gum base. The elastomers (rubbers) employed in the gum base will vary greatly depending upon various factors such as the type of gum base desired, the consistency of gum composition desired and the other components used in the composition to make the final chewing gum product. The elastomer may be any water-insoluble polymer known in the art, and includes those gum polymers utilized for chewing gums and bubble gums. Illustrative examples of suitable polymers in gum bases include both natural and synthetic elastomers. For example, those polymers which are suitable in gum base compositions include, without limitation, natural substances (of vegetable origin) such as chicle, natural rubber, crown gum, nispero, rosidinha, jelutong, perillo, niger gutta, tunu, balata, guttapercha, lechi capsi, sorva, gutta kay, and the like, and combinations thereof. Examples of synthetic elastomers include, without limitation, styrene-butadiene copolymers (SBR), polyisobutylene, isobutylene-isoprene copolymers, polyethylene, polyvinyl acetate and the like, and combinations thereof.

Additional useful polymers include: crosslinked polyvinyl pyrrolidone, polymethylmethacrylate; copolymers of lactic acid, polyhydroxyalkanoates, plasticized ethylcellulose, polyvinyl acetatephthalate and combinations thereof.

The amount of elastomer employed in the gum base may vary depending upon various factors such as the type of gum base used, the consistency of the gum composition desired and the other components used in the composition to make the final chewing gum product. In general, the elastomer will be present in the gum base in an amount from about 10% to about 60% by weight of the gum composition.

In some embodiments, the gum base may include one or more waxes. Wax softens the polymeric elastomer mixture and improves the elasticity of the gum base. When present, the waxes employed generally have a melting point below about 60° C., and preferably between about 45° C. and about 55° C. The low melting wax may be a paraffin wax. The wax may be present in the gum base in an amount from about 6% to about 10%, and specifically from about 7% to about 9.5%, by weight of the gum base.

In addition to the low melting point waxes, waxes having a higher melting point may be used in the gum base in amounts up to about 5%, by weight of the gum base. Such high melting waxes include beeswax, vegetable wax, candelilla wax, carnuba wax, most petroleum waxes, and the like, and mixtures thereof.

In addition to the components set out above, the gum base may include a variety of other ingredients, such as components selected from elastomer solvents, emulsifiers, plasticizers, fillers, and mixtures thereof.

The gum base may contain elastomer solvents to aid in softening the elastomer component. Such elastomer solvents may include those elastomer solvents known in the art, for example, terpinene resins such as polymers of alpha-pinene or beta-pinene, methyl, glycerol and pentaerythritol esters of rosins and modified rosins and gums such as hydrogenated, dimerized and polymerized rosins, and mixtures thereof. Examples of elastomer solvents suitable for use herein may include the pentaerythritol ester of partially hydrogenated wood and gum rosin, the pentaerythritol ester of wood and gum rosin, the glycerol ester of wood rosin, the glycerol ester of partially dimerized wood and gum rosin, the glycerol ester of polymerized wood and gum rosin, the glycerol ester of tall oil rosin, the glycerol ester of wood and gum rosin and the partially hydrogenated wood and gum rosin and the partially hydrogenated methyl ester of wood and rosin, and the like, and mixtures thereof. The elastomer solvent may be employed in the gum base in amounts from about 2% to about 15%, and specifically from about 7% to about 11%, by weight of the gum base.

The gum base may also include emulsifiers which aid in dispersing the immiscible components into a single stable system. The emulsifiers useful in this invention include glyceryl monostearate, lecithin, fatty acid monoglycerides, diglycerides, propylene glycol monostearate, and the like, and mixtures thereof. The emulsifier may be employed in amounts from about 2% to about 15%, and more specifically, from about 7% to about 11%, by weight of the gum base.

The gum base may also include plasticizers or softeners to provide a variety of desirable textures and consistency properties. Because of the low molecular weight of these ingredients, the plasticizers and softeners are able to penetrate the fundamental structure of the gum base making it plastic and less viscous. Useful plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerine, and the like, and mixtures thereof. Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, mixtures thereof, and the like, may also be incorporated into the gum base. The plasticizers and softeners are generally employed in the gum base in amounts up to about 20% by weight of the gum base, and more specifically in amounts from about 9% to about 17%, by weight of the gum base.

Plasticizers also include are the hydrogenated vegetable oils and include soybean oil and cottonseed oil which may be employed alone or in combination. These plasticizers provide the gum base with good texture and soft chew characteristics. These plasticizers and softeners are generally employed in amounts from about 5% to about 14%, and more specifically in amounts from about 5% to about 13.5%, by weight of the gum base.

Anhydrous glycerin may also be employed as a softening agent, such as the commercially available United States Pharmacopeia (USP) grade. Glycerin is a syrupy liquid with a sweet warm taste and has a sweetness of about 60% of that of cane sugar. Because glycerin is hygroscopic, the anhydrous glycerin may be maintained under anhydrous conditions throughout the preparation of the chewing gum composition.

In some embodiments, the gum base of this invention may also include effective amounts of bulking agents such as mineral adjuvants which may serve as fillers and textural agents. Useful mineral adjuvants include calcium carbonate, magnesium carbonate, alumina, aluminum hydroxide, aluminum silicate, talc, tricalcium phosphate, dicalcium phosphate, calcium sulfate and the like, and mixtures thereof. These fillers or adjuvants may be used in the gum base compositions in various amounts. The amount of filler may be present in an amount from about zero to about 40%, and more specifically from about zero to about 30%, by weight of the gum base. In some embodiments, the amount of filler will be from about zero to about 15%, more specifically from about 3% to about 11%.

A variety of traditional ingredients may be optionally included in the gum base in effective amounts such as coloring agents, antioxidants, preservatives, flavoring agents, and the like. For example, titanium dioxide and other dyes suitable for food, drug and cosmetic applications, known as F. D. & C. dyes, may be utilized. An anti-oxidant such as butylated hydroxytoluene (BHT), butylated hydroxyanisole (BHA), propyl gallate, and mixtures thereof, may also be included. Other conventional chewing gum additives known to one having ordinary skill in the chewing gum art may also be used in the gum base.

Methods of extending the release of flavor from gum compositions are also provided. This methods include the preparation of a gum composition including a gum base, a flavor and a surfactant, with or without encapsulation and optionally having HLB of about seven or higher. The gum compositions modulate and/or control the flavor release of the gum over time. Specifically, the gum compositions provide for enhanced flavor release. In some embodiments the flavor release may be controlled by the presence of one or more surfactants such that there is an initial flavor burst or spike followed by an extended period of maintaining the intensity of flavor level. Different combinations of encapsulating materials, surfactants, and HLB levels may be used to tailor the release profile. Desirably, these variables are chosen to maximize the amount of flavor released during chew and provide the user with enhanced flavor perception. Chewing gum compositions employing the present invention may chew longer without loss of flavor, thereby enhancing their period of enjoyment and their perception of a long lasting quality product.

As mentioned above, the surfactant may be in the free or encapsulated form. In one embodiment the surfactant is in the form of encapsulated particles which optionally may have an HLB of seven or greater. Free surfactant may be admixed with the encapsulated surfactant. In such an embodiment, the free surfactant may serve to enhance short term flavor impact and the encapsulated surfactant may serve to prolong the flavor perception. The intensity and duration of flavor perceived can thus be modulated in various ways by the present invention.

In the embodiments which include an encapsulated surfactant. The encapsulation may be effected by either extrusion or a spray coating technique. Several acceptable encapsulating materials are described hereinabove.

Methods of increasing flavor release from a gum composition are also provide which include providing a gum composition comprising a gum base and a flavor and subjecting the gum composition to mastication. Subsequently, a surfactant is added to the gum composition during chewing. Some or all of the subsequently added surfactant may be in an encapsulated form.

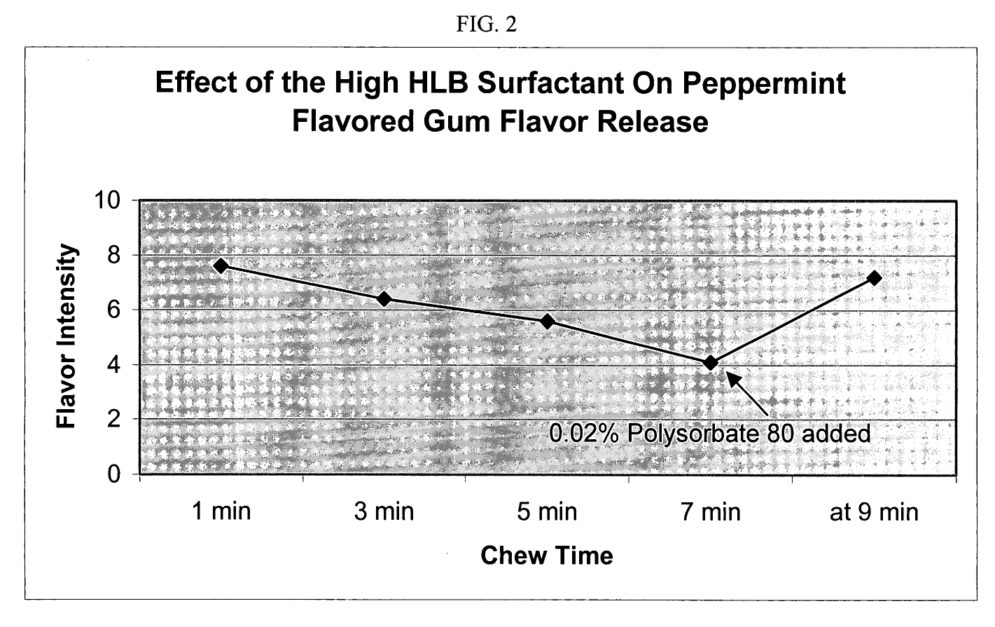

FIG. 2 shows the effect of adding a surfactant to a gum composition during chewing. Polysorbate 80 was added to the gum composition in an amount of 0.02% by weight of the gum composition at seven minutes. The favor intensity was measured on a scale from one to ten with one being lowest and ten being highest. Prior to the surfactant addition, the flavor intensity was four and two minutes following the surfactant addition, the flavor intensity was between seven and eight, close to the initial flavor intensity.

A combination of these methods includes the preparation of a gum composition which includes free surfactant in addition to encapsulated surfactant. This gum composition includes an increase in the amount of surfactant released from the gum as well as an extended release.

The features and advantages of the present invention are more fully shown by the following examples which are provided for purposes of illustration, and are not to be construed as limiting the invention in any way.

### EXAMPLES

### Examples A-H

TABLE 1

| | % by weight | | | | | | | |
|---|---|---|---|---|---|---|---|---|
| Component | A | B | C | D | E | F | G | H |
| Gum base¹ | 30-40 | 30-40 | 25-35 | 25-35 | 22-35 | 30-40 | 30-40 | 25-35 |
| Lecithin | 0.2 | 0 | 0 | 0 | 0 | 0 | 0.2 | 0.2 |
| Bulking Agent | 54-59 | 55-60 | 59-64 | 59-64 | 59-64 | 54-59 | 54-59 | 58-63 |
| ≧7 HLB | 0.04 | 0.1 | 0.3 | 0.5 | 0.7 | 1.0 | 0.04 | 0.04 |
| Surfactant | | | | | | | | |
| Encapsulated ≧7 | 0 | 0 | 0 | 0 | 0 | 0 | 0 | 1.0 |
| HLB Surfactant² | | | | | | | | (2% surfactant) |
| Flavors | 2.45 | 2.45 | 2.45 | 2.45 | 2.45 | 2.45 | 2.45 | 2.45 |
| Cooling agent | 0.76 | 0.76 | 0.76 | 0.76 | 0.76 | 0.76 | 0.76 | 0.76 |
| Glycerine | 4.0 | 4.0 | 4.0 | 4.0 | 4.0 | 4.0 | 4.0 | 4.0 |
| Intense sweetener³ | 2.68 | 2.68 | 2.68 | 2.68 | 2.68 | 2.68 | 2.68 | 2.68 |

¹gum base may include 3% to 25% by weight of a filler such as, for example, talc, dicalcium phosphate, and calcium carbonate (the amount of filler in the gum base is based on the weight percent of the gum region composition, for example, in the above compositions A-H, if a gum region composition includes 5% filler, the amount of gum base will be 5% less than the range recited in the table, i.e., from 23-37%).
²The percent surfactant is based on the total weight of the surfactant and encapsulating materials.
³Intense sweetener may include a combination of encapsulated and non-encapsulated sweeteners.

The compositions for Examples A-H were prepared using the components in Table 1 by first combining the gum base and fillers under heat at about 85° C. This combination was then mixed with the bulking agents, lecithin and glycerin for about five minutes. The flavor blends which include a pre-mix of the flavors, cooling agents and surfactants were added and mixed for one minute. Finally, intense sweeteners were added and mixed for five minutes.

Each of the compositions A-H showed an overall increase in the amount of flavor which was released from the gum composition compared to a composition which did not include a surfactant having HLB greater than or equal to seven. In addition, composition H which included an encapsulated surfactant demonstrated an extended release of flavor.

### Examples I-P

TABLE 2

| | % by weight | | | | | | | |
|---|---|---|---|---|---|---|---|---|
| Component | I | J | K | L | M | N | O | P |
| Gum base¹ | 30-40 | 30-40 | 25-35 | 30 | 30 | 30 | 30 | 25-35 |
| Lecithin | 0.2 | 0.2 | 0.2 | 0 | 0 | 0 | 0 | 0.2 |
| Bulking Agent | 53-58 | 53-58 | 58-63 | 59-64 | 59-64 | 55-65 | 55-65 | 55-65 |
| ≧7 HLB | 0.04 | 0.04 | 0.04 | 0.5 | 0.3 | 0.5 | 0.3 | 0 |
| Surfactant | | | | | | | | |
| Encapsulated ≧7 | 0.5-1 | 0.5-1 | 0.5-1 | 0 | 0 | 0 | 0 | 0.5-1 |
| HLB Surfactant² | (5% surfactant) | (10% surfactant) | (30% surfactant) | | | | | (10% surfactant) |
| Flavors | 2.45 | 2.45 | 2.45 | 2.45 | 2.45 | 2.45 | 2.45 | 2.45 |
| Cooling agent | 0.76 | 0.76 | 0.76 | 0.76 | 0.76 | 0.76 | 0.76 | 0.76 |
| Glycerine | 4.0 | 4.0 | 4.0 | 4.0 | 4.0 | 4.0 | 4.0 | 4.0 |
| Intense sweetener³ | 2.68 | 2.68 | 2.68 | 2.68 | 2.68 | 2.68 | 2.68 | 2.68 |

¹gum base may include 3% to 25% by weight of a filler such as, for example, talc, dicalcium phosphate, and calcium carbonate (the amount of filler in the gum base is based on the weight percent of the gum region composition, for example, in the above compositions I-P, if a gum region composition includes 5% filler, the amount of gum base will be 5% less than the range recited in the table, i.e., from 23-37%).
²The percent surfactant is based on the total weight of the surfactant and encapsulating materials.
³Intense sweetener may include a combination of encapsulated and non-encapsulated sweeteners.

The compositions for Examples I-P were prepared using the components in Table 2 by first combining the gum base and fillers under heat at about 85° C. This combination was then mixed with the bulking agents, lecithin and glycerin for about five minutes. The flavor blends which include a pre-mix of the flavors, cooling agents, and surfactants were added and mixed for 1 minute. Finally, intense sweeteners were added and mixed for five minutes.

Each of the compositions I-P showed an overall increase in the amount of flavor which was released from the gum composition compared to a composition which did not include a surfactant having HLB greater than or equal to seven. In addition, compositions I, J, K, and P which included an encapsulated surfactant demonstrated an extended release of flavor.

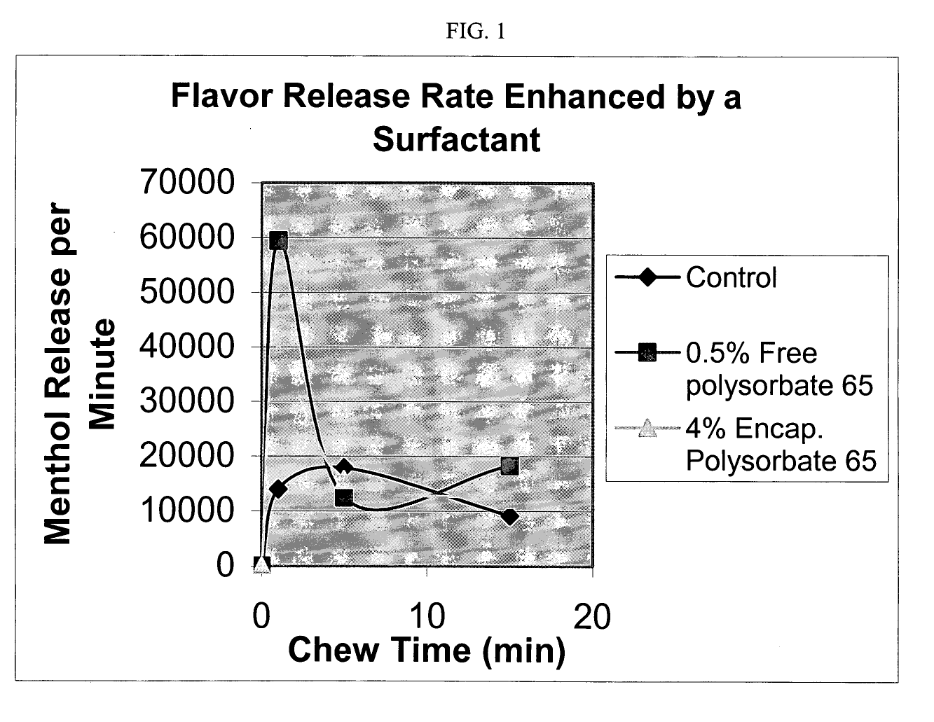

FIG. 1 shows a comparison of the menthol release rates of gum compositions including menthol over the time that the composition is chewed. The three compositions which were compared include a control having no surfactant, a composition including 0.5% free (unencapsulated) surfactant, and a composition including 4% by weight of an encapsulated surfactant. The compositions which include surfactant showed significantly higher release rates of the menthol, particularly during the first five minutes of chewing.

While there have been described what are presently believed to be the preferred embodiments of the invention, those skilled in the art will realize that changes and modifications may be made thereto without departing from the spirit of the invention, and it is intended to include all such changes and modifications as fall within the true scope of the invention.

1. An encapsulated composition comprising:
(a) a core material comprising at least one surfactant having an HLB sufficient to create an oil and water emulsion;
(b) an exterior coating encapsulating the core comprising a material selected from the group consisting of cellulose, cellulose derivatives, starches, carbohydrates, gums, polyolefins, proteins, polyesters, waxes, vinyl polymers, gelatin, zein and combinations thereof.

2. The composition of claim 1, wherein said surfactant has an HLB of about seven or greater.

3. The composition of claim 1, wherein said surfactant has an HLB of about fifteen or less.

4. The composition of claim 1, wherein said core material comprises a flavor oil.

5. The composition of claim 1, wherein said core material further comprises an active component.

6. The composition of claim 3, wherein said active component is selected from the group consisting of sweeteners, flavors, sensates, breath-freshening agents, medicaments or pharmaceutical actives, analgesics, anti-histamines, decongestants, antacids, vitamins, dietary supplements, breath freshening agents, caffeine, nicotine, and combinations thereof.

7. The composition of claim 1, wherein said surfactant is selected from the group consisting of polyglycerol esters, ceteareth-20, sorbitan monostearate, sorbitan monooleate, sorbitan laurate, polyglyceryl laurate, glyceryl cocoate, acacia gum, acetylated monoglyceride, and combinations thereof.

8. The composition of claim 1, wherein said exterior coating comprises a polymer selected from the group consisting of polyethylene, crosslinked polyvinyl pyrrolidone, polymethylmethacrylate, polylactic acid, polyhydroxyalkanoates, ethylcellulose, polyvinyl acetate phthalate, polyethyleneglycol esters, methacrylic acid-co-methylmethacrylate, acrylic polymers and copolymers, carboxyvinyl polymer, polyamides, polystyrene, polyvinyl acetate and combinations thereof.

9. The composition of claim 1, further comprising a tensile strength modifying agent.

10-36. (canceled)

37. A composition comprising:
(a) a chewable matrix;
(b) at least one flavor; and
(c) encapsulated surfactant particles.

38. A composition comprising:
(a) a gum base;
(b) at least one flavor; and
(c) encapsulated surfactant particles.

39. The composition of claim 32, wherein said encapsulated surfactant comprises an encapsulating material selected from the group consisting of cellulose, cellulose derivatives, starches, carbohydrates, gums, polyolefins, polyesters, waxes, vinyl polymers, gelatin, zein and combinations thereof.

40. The composition of claim 33, wherein said composition further comprises a tensile strength modifying composition.

41. The composition of claim 32, wherein said encapsulated particles further comprise a flavor.

42. The composition of claim 33, wherein said encapsulated surfactant particles comprises a polymer selected from the group consisting of polyethylene, crosslinked polyvinyl pyrrolidone, polymethylmethacrylate, polylactic acid, polyhydroxyalkanoates, ethylcellulose, polyvinyl acetate phthalate, polyethyleneglycol esters, methacrylic acid-co-methylmethacrylate, acrylic polymers and copolymers, carboxyvinyl polymer, polyamides, polystyrene, polyvinyl acetate and combinations thereof.

43. The composition of claim 32, wherein said encapsulated surfactant particles comprise from about 0.01% to about 5% by weight of said composition.

44. The composition of claim 32, wherein said encapsulated surfactant particles comprise a surfactant from about 2% to about 30% by weight of said encapsulated surfactant particles.

45. A method of extending release of flavor from a gum composition comprising providing a gum composition comprising a gum base, at least one flavor and a surfactant having an HLB higher than about seven.

46. The method of claim 39, wherein said surfactant is encapsulated.

47. The method of claim 39, wherein said surfactant is encapsulated by a polymer.

48. The method of claim 41, wherein said polymer is selected from the group consisting of polyethylene, crosslinked polyvinyl pyrrolidone, polymethylmethacrylate, polylactic acid, polyhydroxyalkanoates, ethylcellulose, polyvinyl acetate phthalate, polyethyleneglycol esters, methacrylic acid-co-methylmethacrylate, acrylic polymers and copolymers, carboxyvinyl polymer, polyamides, polystyrene, polyvinyl acetate and combinations thereof

49. (canceled)

50. The method of claim 43, wherein said surfactant comprises an encapsulated surfactant.

51. The method of claim 44, wherein said encapsulated surfactant further comprises a flavor.

52. A method of providing extended flavor release in a chewable composition comprising:
(a) providing a chewable matrix; and
(b) combining said matrix with a flavor and encapsulated surfactant particles.

53. The method of claim 46, wherein said encapsulated surfactant particles comprise a surfactant selected from the group consisting of polyglycerol esters, ceteareth-20, sorbitan monostearate, sorbitan monooleate, sorbitan laurate, polyglyceryl laurate, glyceryl cocoate, acacia gum, acetylated monoglyceride, and combinations thereof.

54. The method of claim 46, wherein said encapsulated surfactant particles include an encapsulating material selected from the group consisting of group consisting of cellulose, cellulose derivatives, starches, carbohydrates, gums, polyolefins, polyesters, waxes, vinyl polymers, gelatin, zein, and combinations thereof.

55. The method of claim 48, wherein said encapsulating material comprises a polymer selected from the group consisting of polyethylene, crosslinked polyvinyl pyrrolidone, polymethylmethacrylate, polylactic acid, polyhydroxyalkanoates, ethylcellulose, polyvinyl acetate phthalate, polyethyleneglycol esters, methacrylic acid-co-methylmethacrylate, acrylic polymers and copolymers, carboxyvinyl polymer, polyamides, polystyrene, polyvinyl acetate and combinations thereof.

56. The method of claim 48, wherein said chewable composition further comprises a tensile strength modifying composition.

57. (canceled)
